(19) United States
(12) Patent Application Publication
(10) Pub. No.: US 2026/0218855 A1
(43) Pub. Date: Jul. 30, 2026

(54) Conformal Cryogenic Tank

(71) Applicant: The Boeing Company, Arlington, VA (US)

(72) Inventors: John Alfred Weidler, McKinney, TX (US); Charles William Rust, Seattle, WA (US)

(21) Appl. No.: 19/036,279

(22) Filed: Jan. 24, 2025

(51) Int. Cl. F17C 3/08; B64D 37/06; B64F 5/10

(52) U.S. Cl. CPC F17C 3/08; B64D 37/06; B64F 5/10; F17C 2201/0119; F17C 2203/0391; F17C 2203/0621; F17C 2203/0636; F17C 2209/2109; F17C 2209/232; F17C 2221/012; F17C 2223/0161; F17C 2270/0189

(57) ABSTRACT

A cryogenic fuel tank system for an aircraft and method for forming. The cryogenic fuel tank system includes a first outer sheet, an inner sheet, a second outer sheet, and a space between the first outer sheet and the second outer sheet. The inner sheet is bonded to the first outer sheet at a first set of bond locations. The inner sheet is bonded to the second outer sheet at a second set of bond locations. The first set of bond locations are offset from the second set of bond locations. The space comprises a vacuum. The inner sheet extends between the first outer sheet and the second outer sheet and forms an integrally formed support structure between the first outer sheet and the second outer sheet.

### BACKGROUND INFORMATION

### 1. Field

The present disclosure relates generally to aircraft. More specifically, the present disclosure relates to aircraft using propulsion systems powered using cleaner emission fuel alternatives such as hydrogen stored in cryogenic fuel tanks conformally shaped to fit specific locations of the aircraft.

### 2. Background

As traditional jet fuel prices or carbon taxes rise, when combined with climate change, there is more incentive over time to use alternative fuels, such as cryogenic fuels, for powering large commercial aircraft.

One such cryogenic fuel is hydrogen. As a fuel source, cryogenic fuels are typically stored in liquid form. Liquid cryogenic fuels, such as hydrogen fuel, need to be stored at cryogenic temperatures. In order to provide enough fuel for an aircraft to perform normally, large onboard cryogenic tanks are required for each aircraft.

Cryogenic storage of liquids requires tanks that are significantly insulated. Currently, Dewar style double wall tanks are commonly used for cryogenic storage of liquids. These tanks typically comprise 3/16″ inch thick stainless steel inner and outer walls and are usually cylindrical in shape with rounded end caps.

These tanks are either heavy, fragile, or both; characteristics not conducive to use in aircraft. In addition to the extra weight and fragility concerns, other issues include where to position the cryogenic tanks within the aircraft without upsetting the flight dynamics of the aircraft and without compromising the structural integrity of the aircraft. Further, Dewar style tanks are difficult to manufacture in any shape that is not a sphere or cylinder with spherical ends.

Therefore, it would be desirable to have a method and apparatus that takes into account at least some of the issues discussed above, as well as other possible issues.

### SUMMARY

An illustrative embodiment of the present disclosure provides a cryogenic fuel tank for an aircraft. The cryogenic fuel tank includes a first outer sheet, an inner sheet, and a second outer sheet. The first outer sheet is spaced from the second outer sheet. The inner sheet is positioned between the first outer sheet and the second outer sheet. The inner sheet is bonded to the first outer sheet at a first set of bond locations. The inner sheet is bonded to the second outer sheet at a second set of bond locations. The first set of bond locations are offset from the second set of bond locations.

Another illustrative embodiment of the present disclosure provides a cryogenic fuel tank system for an aircraft. The cryogenic fuel tank system includes a first outer sheet, an inner sheet, a second outer sheet, and a space between the first outer sheet and the second outer sheet. The first outer sheet is bonded to the inner sheet. The second outer sheet bonded to the inner sheet. The space comprises a vacuum. The inner sheet extends between the first outer sheet and the second outer sheet and forms an integrally formed support structure between the first outer sheet and the second outer sheet.

A further illustrative embodiment of the present disclosure provides a method for forming a cryogenic fuel tank for an aircraft. A first outer sheet is bonded to an inner sheet at a first set of bond locations. A second outer sheet is bonded to the inner sheet at a second set of bond locations. The second set of bond locations is offset from the first set of bond locations. A space between the first outer sheet and the second outer sheet is expanded such that the inner sheet extends between the first outer sheet and the second outer sheet and forms an integrally formed support structure extending from the first set of bond locations to the second set of bond locations.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a platform in accordance with an illustrative embodiment;

FIG. 2 is an illustration of an aircraft with a cryogenic fuel tank in accordance with an illustrative embodiment;

FIG. 3 is an illustration of a wing section of an aircraft with a cryogenic fuel tank in accordance with an illustrative embodiment;

FIG. 4 is an illustration of a wall of a cryogenic fuel tank in perspective in accordance with an illustrative embodiment;

FIG. 5 is an illustration of a wall of a cryogenic fuel tank in a top or bottom plan view in accordance with an illustrative embodiment;

FIG. 6 is an illustration of a wall of a cryogenic fuel tank in perspective in accordance with an illustrative embodiment;

FIG. 7 is an illustration of a wall of a cryogenic fuel tank in a top or bottom plan view in accordance with an illustrative embodiment;

FIG. 8 is an illustration of a wall of a cryogenic fuel tank in a sectional view in accordance with an illustrative embodiment;

FIG. 9 is an illustration of a flowchart of a process for forming a cryogenic fuel tank for an aircraft in accordance with an illustrative embodiment;

FIG. 10 is an illustration of an aircraft manufacturing and service method in accordance with an illustrative embodiment; and

FIG. 11 is an illustration of a block diagram of an aircraft in which an illustrative embodiment may be implemented.

### DETAILED DESCRIPTION

The illustrative embodiments recognize and take into account a number of different issues with respect to aircraft that operate using cryogenic fuel sources such as liquid hydrogen fuel. The issues recognized by the different illustrative embodiments are described herein.

The illustrative embodiments recognize and take into account that integrating a liquid hydrogen (LH2) system into a passenger aircraft, such as a large commercial aircraft, can be challenging. For example, design challenges are present in determining where to locate the large cryogenic fuel tanks safely and how to package the thermal management.

The illustrative embodiments recognize and take into account that typical Dewar style cryogenic tanks typically used to store cryogenic liquids such as liquid hydrogen are heavy and shape constrained.

In these illustrative examples, the location of the cryogenic fuel tanks is important. It is beneficial to take advantage of specifically shaped space within an aircraft that is already commonly used for fuel tank location, such as within the wings and fuselage structure.

The illustrated examples incorporate an application of a manufacturing technology known as Super Plastic Formed Diffusion Bonded Titanium. The illustrated examples provide a structural configuration using titanium that allows for light weight design while maintaining high strength and insulative capability. The illustrated examples disclose thin titanium sheets that are uniformly connected allowing a large structural mass of inertia in a lightweight material. The walls of the cryogenic fuel tank include at least two layers of thin titanium sheets. A cavity under vacuum between the thin sheets protects against thermal loss.

In these illustrated examples, the thin titanium sheets are integrally supported by each other in a truss like structure.

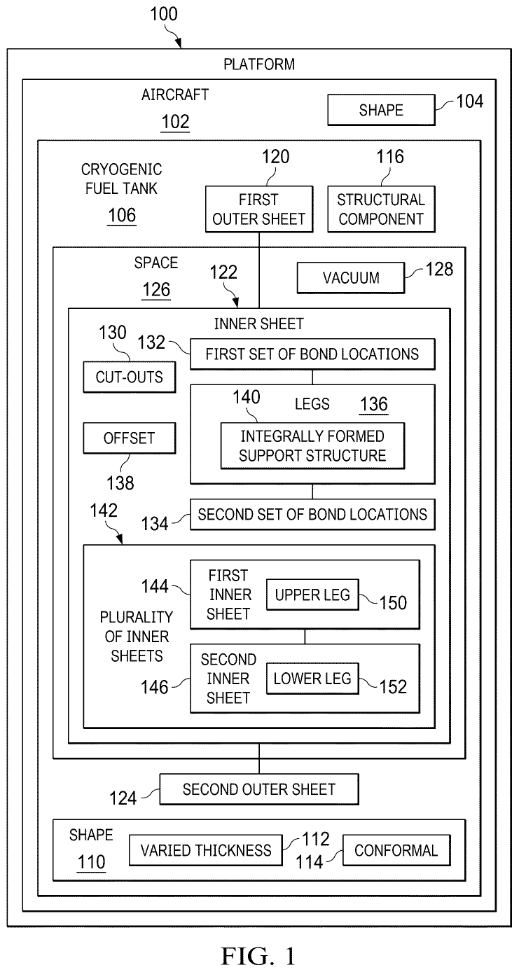

With reference now to the figures and, in particular, with reference to FIG. 1, an illustration of a block diagram of a platform is depicted in accordance with an illustrative example. Platform 100 has aircraft 102 in this illustrative example.

The illustration of aircraft 102 in FIG. 1 is not meant to imply physical or architectural limitations to the manner in which an illustrative example may be implemented. For example, although aircraft 102 may be a commercial aircraft, aircraft 102 may be a military aircraft, a rotorcraft, a helicopter, an unmanned aerial vehicle, or any other suitable aircraft.

Although the illustrative examples are described with respect to an aircraft, the illustrative example may be applied to other types of platforms. The platform may be, for example, a mobile platform, a stationary platform, a land-based structure, an aquatic-based structure, or a space-based structure. More specifically, the platform may be an aircraft, a surface ship, a tank, a personnel carrier, a train, a spacecraft, a space station, a satellite, a submarine, an automobile, a power plant, a bridge, a dam, a house, a manufacturing facility, a building, a tool, a mechanical structure, or some other suitable platform or structure where a cryogenic fuel tank is desirable.

In this illustrative example, platform 100 takes the form of aircraft 102. In this illustrative example, when platform 100 takes the form of aircraft 102, aircraft 102 includes shape 104 and cryogenic fuel tank 106. Shape 104 is any specific shape of an open space present in the aircraft, such as the fuselage or the wings, where a fuel tank could be positioned. Shape 104 may be conducive to a fuel tank that is cylindrical shaped with domed ends, but may also be a shape other than cylindrical. Cryogenic fuel tank 106 will fit within shape 104. It is understood that cryogenic fuel tank is manufactured to conform to shape 104 of aircraft 102 and is not limited by the constrained shape requirements of Dewar style cryogenic tanks.

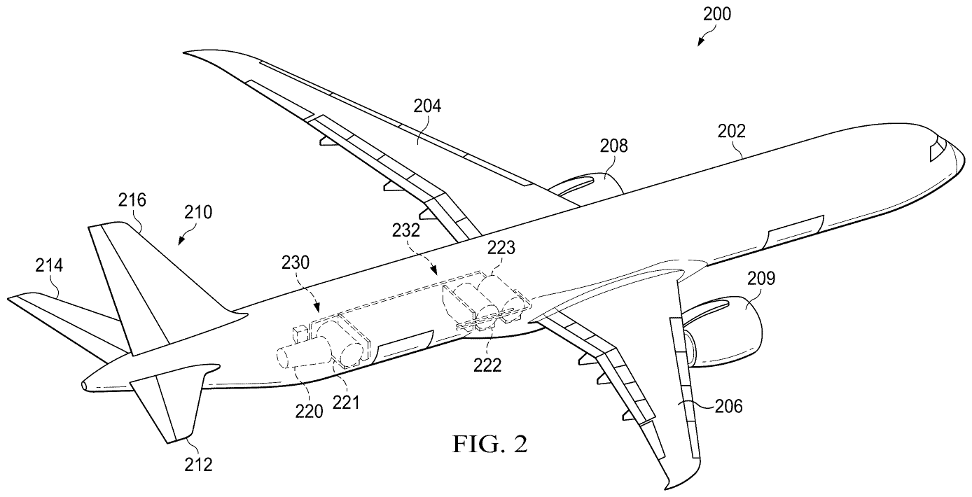

Cryogenic fuel tank 106 has shape 110. Shape 110 is conformal 114 to shape 104 of aircraft 102. In other words, cryogenic fuel tank 106 may be manufactured to a shape of an open or preexisting space of aircraft 102. Cryogenic fuel tank 106 is molded to shape 110 such that cryogenic fuel tank 106 will fit shape 104 of aircraft 102. Shape 110 may also have varied thickness 112. Shape 110 of cryogenic fuel tank 106 is conformal 114, thus cryogenic fuel tank 106 may be molded between dies to achieve shape 110. Shape 110 fits within shape 104 of aircraft 102. Cryogenic fuel tank 106 may also become structural component 116 of aircraft 102. In other words, since cryogenic fuel tank 106 is conformal 114 to shape 104 of aircraft, cryogenic fuel tank 106 may replace a structural component of aircraft 102, for example, wings 204, 206 (See FIG. 2) consisting of upper and lower structure wing surfaces, forward and aft structural spars and end bulkheads or elements of the wings with intermediate bulkheads forming a side or multiple sides of a tank. Other examples of structural components of aircraft that may be replaced or supplemented with a cryogenic tank include the center box (fuselage structure that attaches the wings to the fuselage), segments of the structural portions of a center fuel tank, other box structural locations such as horizontal stabilizers 212, 214, vertical stabilizer 216, and areas in the low lobe below between the cargo compartment and the low body surface formed with various stringers, longerons, bulkheads, and floor beams. Cryogenic fuel tank 106 may serve a dual purpose of storing cryogenic fuels while also while also replacing a typical structural component of the aircraft and serving as structural component 116.

Cryogenic fuel tank 106 is a double-walled, insulated tank for cryogenic storage of liquids. Cryogenic fuel tank 106 is manufactured using Super Plastic Formed Diffusion Bonded titanium (SPFDB). The double-walled structural configuration using titanium allows for a lightweight design while maintaining high strength and insulative capability. Cryogenic fuel tank 106 includes thin titanium sheets that are uniformly connected allowing a large structural mass of inertia in a lightweight material. The titanium material and a cavity between the thin sheets under vacuum create low thermal loss.

The walls of cryogenic fuel tank 106 include first outer sheet 120, inner sheet 122, and second outer sheet 124. Space 126 exists between first outer sheet 120 and second outer sheet 124. In other words, first outer sheet 120 is spaced from second outer sheet 124 by space 126. Inner sheet 122 is positioned within space 126. Inner sheet 122 is bonded to both first outer sheet 120 and second outer sheet 124. Space 126 includes vacuum 128. Vacuum 128 helps insulate cryogenic fuel tank 106 and reduce thermal loss.

First outer sheet 120, inner sheet 122, and second outer sheet 124 each may be comprised of thin sheets of titanium. It is understood that first outer sheet 120, inner sheet 122, and second outer sheet 124 may range in thickness from 0.025-0.050 inches. First outer sheet 120, inner sheet 122, and second outer sheet 124 may also all have the same or different thicknesses. It is understood that titanium in the thickness range provides the necessary strength and weight that is conducive for aerospace applications, however, it is understood other materials having similar properties may be used such as, steel, stainless steel, and aluminum are all capable of SPFDB. Dissimilar metals may also be used.

First outer sheet 120 and second outer sheet 124 are continuous sheets of material. Inner sheet 122 may be a continuous sheet of material or inner sheet 122 may include cut-outs 130. Cut-outs 130 may be any shape desired and not all cut-outs need be the same shape. The shape of cut-outs 130 will be determined by the desired use of inner sheet 122. Non-limiting shapes of cut-outs 130 may include, for example, circular, oval, square, diamond, triangular, rectangular, etc.

Inner sheet 122 is bonded to first outer sheet 120 at first set of bond locations 132. Inner sheet 122 is bonded to second outer sheet 124 at second set of bond locations 134. As is a characteristic of SPFDB, inner sheet 122 is diffusion bonded to both first outer sheet 120 and second outer sheet 124 at first set of bond locations 132 and second set of bond locations 134, respectively. First set of bond locations 132 is offset 138 from second set of bond locations 134. In other words, any bond location of first set of bond locations 132 does not coincide with any bond location of second set of bond locations 134 on an axis perpendicular to the thickness of first outer sheet 120 or second outer sheet 124.

Inner sheet 122 extends from first set of bond locations 132 at first outer sheet 120 across and through space 126 to second set of bond locations 134 at second outer sheet 124. Inner sheet 122 forms legs 136 as inner sheet 122 extends between first outer sheet 120 and second outer sheet 124. Legs 136 of inner sheet 122 form integrally formed support structure 140 bonded to and extending between first outer sheet 120 and second outer sheet 124. Legs 136 integrally support first outer sheet 120 and second outer sheet 124 in a truss like structure. Integrally formed support structure 140 is a truss like structure. Space 126 is evacuated such that space 126 includes vacuum 128.

First outer sheet 120 spaced from second outer sheet 124 combined with and connected to legs 136 provide a structural configuration using titanium that allows for light weight design while maintaining high strength and insulative capability. First outer sheet 120 spaced from second outer sheet 124 are uniformly connected with legs 136 allowing a large structural mass of inertia in a lightweight material. Space 126 under vacuum between first outer sheet 120 and from second outer sheet 124 protects against thermal loss for cryogenic fuel tank 106.

Inner sheet 122 may be plurality of inner sheets 142. Plurality of inner sheets 142 includes at least first inner sheet 144 and second inner sheet 146. First inner sheet 144 is bonded to first outer sheet 120 at first set of bond locations 132. Second inner sheet 146 is bonded to second outer sheet 124 at second set of bond locations 132. When inner sheet 122 is plurality of inner sheets, first set of bond locations 132 may not be offset 138 from second set of bond locations 134. First inner sheet 144 may be folded upon itself or bonded to itself to form upper leg 150. Upper leg 150 extends from first outer sheet 120 across a portion of space 126 towards second outer sheet 124. Second inner sheet 146 may be folded upon itself or bonded to itself to form lower leg 152. Lower leg 152 extends from second outer sheet 124 across a portion of space 126 towards first outer sheet 120. First inner sheet 144 is bonded to second inner sheet 146. Upper leg 150 is bonded to lower leg 152 forming a complete leg or tower between first outer sheet 120 and second outer sheet 124.

As used herein, a first component “connected to” or “coupled to” or “associated with” a second component means that the first component can be connected directly or indirectly to the second component. The connection is a physical association. In other words, additional components may be present between the first component and the second component. The first component is considered to be indirectly connected to the second component when one or more additional components are present between the two components. When the first component is directly connected to the second component, no additional components are present between the two components.

For example, a first component can be considered to be physically connected to a second component by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both.

As used herein, a “set of,” when used with reference to items, means one or more items. For example, a “set of bond locations” is one or more bond locations.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

With reference next to FIG. 2, an illustration of an aircraft with cryogenic fuel tanks mounted within a space having a shape. In this illustrative example and the illustrative examples that follow, the same reference numeral may be used in more than one figure. This reuse of a reference numeral in different figures represents the same element in the different figures. The components illustrated in FIG. 2 are examples of physical implementations of aircraft 102, shape 104, and cryogenic fuel tank 106 shown in block form in FIG. 1.

As illustrated, aircraft 200 includes fuselage 202. Aircraft 200 has wing 204 and wing 206 connected to fuselage 202. Aircraft 200 includes engine 208 connected to wing 204. Aircraft 200 includes engine 209 connected to wing 206. Fuselage 202 has tail section 210. Horizontal stabilizer 212, horizontal stabilizer 214, and vertical stabilizer 216 are connected to tail section 210 of fuselage 202. Cryogenic fuel tank 220 and cryogenic fuel tank 221 are conformally shaped to fit within a space having shape 230 within fuselage 202 of aircraft 200. Cryogenic fuel tank 222 and cryogenic fuel tank 223 are conformally shaped to fit within a space having shape 232 within fuselage 202 of aircraft 200. Although cryogenic fuel tank 222 and cryogenic fuel tank 223 are depicted as cylindrical, the shape of each tank may be conformed to fit within any particular space the aircraft. Cryogenic fuel tanks 220 and 221 are manufactured using SPFDB to be shaped to fit within shape 230. Cryogenic fuel tanks 222 and 223 are manufactured using SPFDB to be shaped to fit within shape 232. Cryogenic fuel tanks 220, 221, 222, and 223 may form a structural component of aircraft 200.

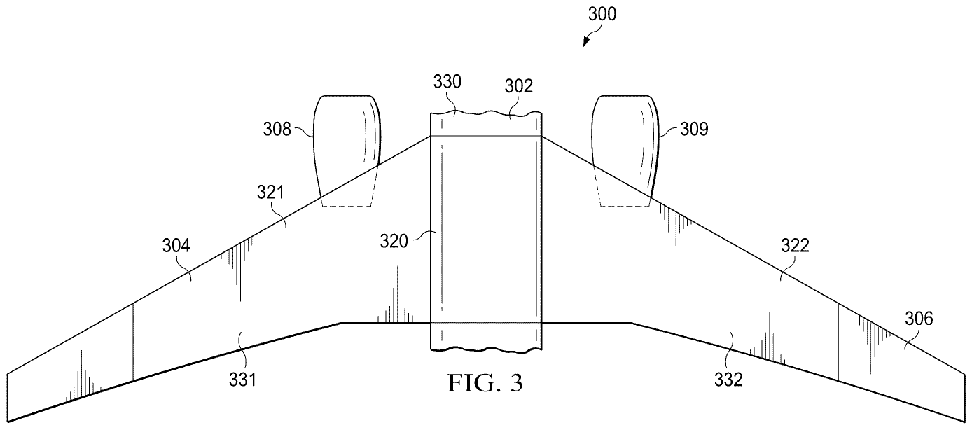

With reference next to FIG. 3, an illustration of a wing section and a portion of a fuselage of an aircraft with cryogenic fuel tanks within a space having a shape. The components illustrated in FIG. 3 are examples of physical implementations of aircraft 102, shape 104, and cryogenic fuel tank 106 shown in block form in FIG. 1.

As illustrated, aircraft 300 includes fuselage 302. Aircraft 300 has wing 304 and wing 306 connected to fuselage 302. Aircraft 300 includes engine 308 connected to wing 304. Aircraft 300 includes engine 309 connected to wing 306. Cryogenic fuel tank 320 is a central fuel tank and is conformally shaped to fit within space 330 within fuselage 302 of aircraft 300. Cryogenic fuel tank 321 is a wing fuel tank and is conformally shaped to fit within space 331 within wing 304 of aircraft 300. Cryogenic fuel tank 322 is a wing fuel tank and is conformally shaped to fit within space 332 within wing 306 of aircraft 300. Cryogenic fuel tanks 320, 321, and 322 are manufactured using SPFDB to be shaped to fit within spaces 330, 331, and 332, respectively. Cryogenic fuel tanks 320, 321, and 322 may form a structural component of aircraft 300.

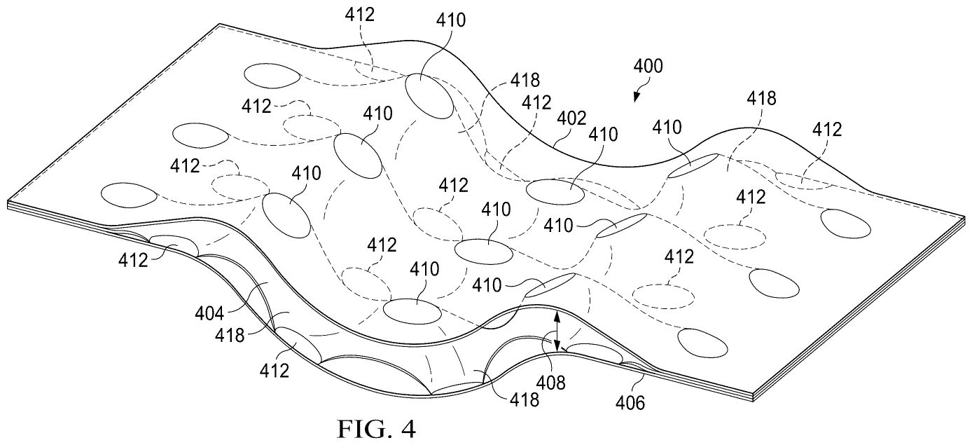

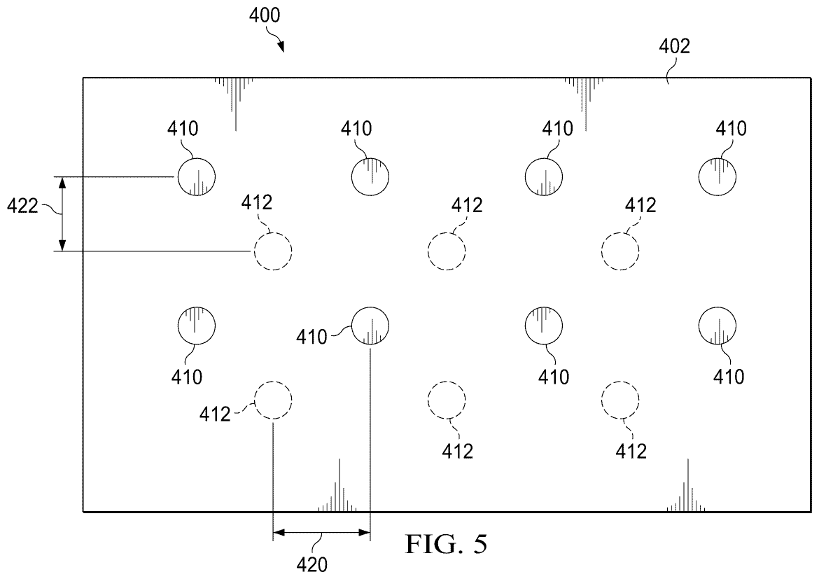

With reference next to FIGS. 4-5, illustrations of a wall of a cryogenic fuel tank in accordance with an illustrative example. FIG. 4 is a perspective view while FIG. 5 is a top or bottom plan view. The components illustrated in FIGS. 4-5 are examples of physical implementations of cryogenic fuel tank 106 shown in block form in FIG. 1.

A portion of wall 400 of a cryogenic fuel tank is illustrated. Wall 400 is a double walled structure formed using SPFDB. Once formed, wall 400, and possibly in combination with additional walls, is shaped between dies to form a cryogenic fuel tank shaped to fit a shape of an aircraft.

Wall 400 comprises first outer sheet 402, inner sheet 404, and second outer sheet 406. Space 408 exists between first outer sheet 402 and second outer sheet 406. In other words, first outer sheet 402 is spaced from second outer sheet 406 by space 408. Inner sheet 404 is positioned within space 408. Inner sheet 404 is bonded to both first outer sheet 402 and second outer sheet 406. Space 408 is evacuated to include a vacuum. The vacuum in space 408 helps insulate a cryogenic fuel tank formed with wall 400 and reduces thermal loss.

First outer sheet 402, inner sheet 404, and second outer sheet 406 each may be comprised of thin sheets of titanium. As illustrated in FIGS. 4-5, first outer sheet 402, inner sheet 404, and second outer sheet 406 are continuous sheets of material.

Inner sheet 404 is diffusion bonded to both first outer sheet 402 and second outer sheet 406 at first set of bond locations 410 and second set of bond locations 412, respectively. First set of bond locations 410 is offset from second set of bond locations 412 in perpendicular lateral directions. The distance of the offsets, illustrated as 420 and 422, is determined by the desired use of the cryogenic fuel tank formed with wall 400. Stated another way, any bond location of first set of bond locations 410 does not coincide with any bond location of second set of bond locations 412 on an axis perpendicular to the thickness of first outer sheet 402 or second outer sheet 406.

Inner sheet 404 extends from first set of bond locations 410 at first outer sheet 402 through space 408 to second set of bond locations 412 at second outer sheet 406. Inner sheet 404 forms legs 418 as inner sheet 404 extends between first outer sheet 402 and second outer sheet 406. Legs 418 of inner sheet 404 form an integrally formed support structure bonded to and extending between first outer sheet 402 and second outer sheet 406. Legs 418 integrally support first outer sheet 402 and second outer sheet 406 in a truss like structure. Distances 420 and 422 of the offset between first set of bond locations 410 and second set of bond locations 412 influence the shape and length of legs 418. The integrally formed support structure formed by legs 418 is a truss like structure.

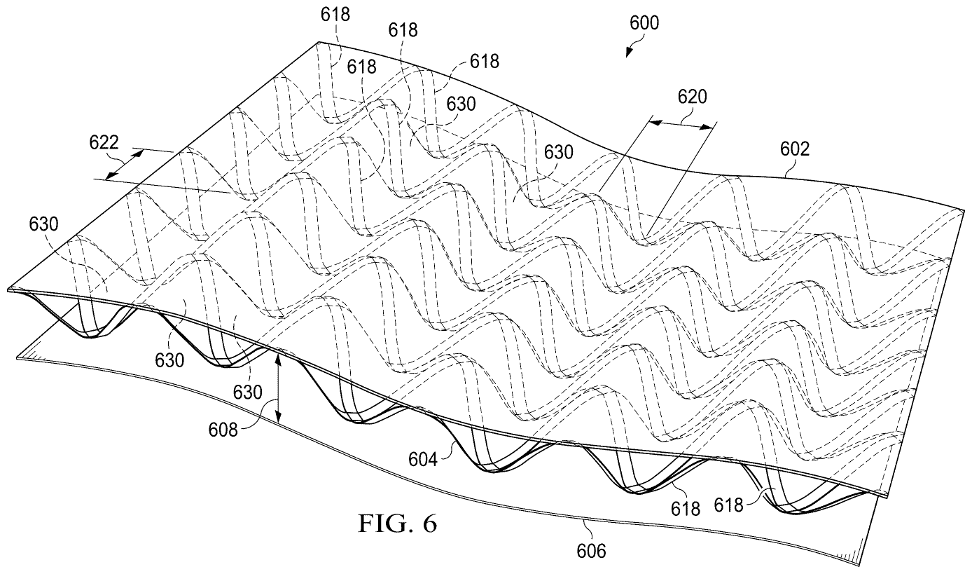

With reference next to FIG. 6, an illustration of a wall of a cryogenic fuel tank in accordance with an illustrative example. The components illustrated in FIG. 6 are examples of physical implementations of cryogenic fuel tank 106 shown in block form in FIG. 1.

A portion of wall 600 of a cryogenic fuel tank is illustrated. Wall 600 is a double walled structure formed using (SPFDB). Once formed, wall 600, and possibly in combination with additional walls, is shaped between dies to form a cryogenic fuel tank shaped to fit a shape of an aircraft.

Wall 600 comprises first outer sheet 602, inner sheet 604, and second outer sheet 606. Space 608 exists between first outer sheet 602 and second outer sheet 606. First outer sheet 602 is spaced from second outer sheet 606 by space 608. Inner sheet 604 is positioned within space 608. Inner sheet 604 is bonded to both first outer sheet 602 and second outer sheet 606. Space 608 is evacuated to include a vacuum. The vacuum in space 608 helps insulate a cryogenic fuel tank formed with wall 600 to reduce thermal loss of any cryogenic liquids stored within.

First outer sheet 602 and second outer sheet 606 each may be comprised of continuous thin sheets of titanium or similar material. Inner sheet 604, also comprised of titanium or similar material, includes cut-outs 630. Cut-outs 630 may be any shape desired and not all cut-outs need be the same shape. The shape of cut-outs 630 will be determined by the desired use of wall 600.

Inner sheet 604 is diffusion bonded to first outer sheet 602 at first set of bond locations 610. Inner sheet 604 is bonded to second outer sheet 606 at second set of bond locations 612. First set of bond locations 610 is offset from second set of bond locations 612 in perpendicular lateral directions. Cut-outs 630 are positioned laterally between first set of bond locations 610 and second set of bond locations 612. The distance of the offsets, illustrated as 620 and 622, is determined by the desired use of the cryogenic fuel tank formed with wall 600. As previously described, any bond location of first set of bond locations 610 does not coincide with any bond location of second set of bond locations 612 on an axis perpendicular to the thickness of first outer sheet 602 or second outer sheet 606.

Inner sheet 604 extends from first set of bond locations 610 at first outer sheet 602 through space 608 to second set of bond locations 612 at second outer sheet 606. Inner sheet 604 forms legs 618 as inner sheet 604 extends between first outer sheet 602 and second outer sheet 606. Legs 618 of inner sheet 604 form an integrally formed support structure bonded to and extending between first outer sheet 602 and second outer sheet 606. Legs 618 integrally support first outer sheet 602 and second outer sheet 606 in a truss like structure. Distances 620 and 622 of the offset between first set of bond locations 610 and second set of bond locations 612 combined with the shape of cut-outs 630 influence the shape and length of legs 618. The integrally formed support structure formed by legs 618 is a truss like structure.

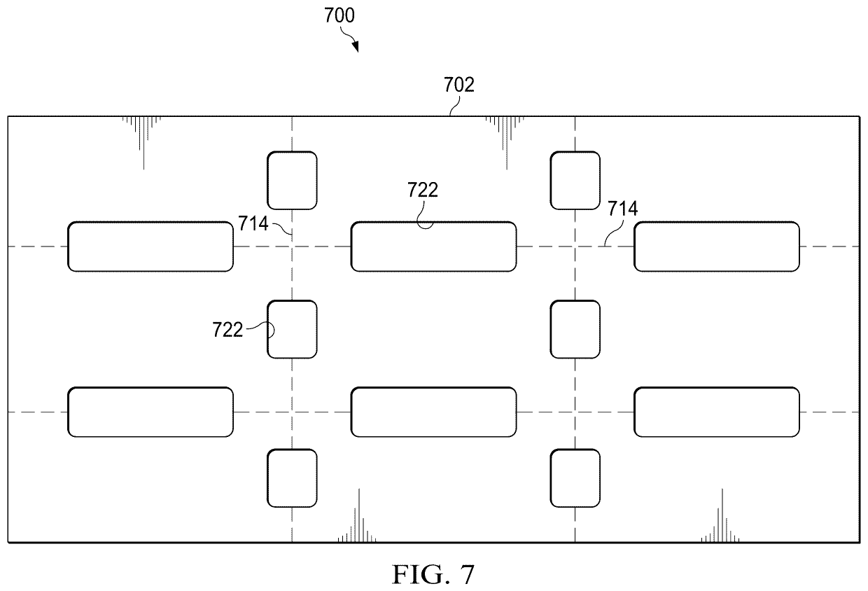

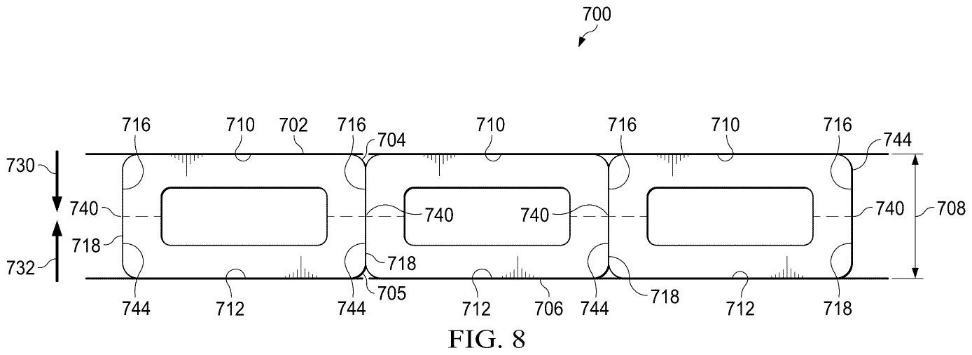

With reference next to FIGS. 7-8, illustrations of a wall of a cryogenic fuel tank in accordance with an illustrative example. FIG. 7 is a top or bottom plan view while FIG. 8 is sectional side view. The components illustrated in FIGS. 7-8 are examples of physical implementations of cryogenic fuel tank 106 and plurality of inner sheets 142 shown in block form in FIG. 1.

A portion of wall 700 of a cryogenic fuel tank is illustrated. Wall 700 is a double walled structure formed using (SPFDB). Once formed, wall 700, and possibly in combination with additional walls, is shaped between dies to form a cryogenic fuel tank shaped to fit a shape of an aircraft.

Wall 700 comprises first outer sheet 702, first inner sheet 704, second inner sheet 705, and second outer sheet 706. Wall 700 is illustrated with two inner sheets, it is understood that any plurality of inner sheets is envisioned and wall 700 is not limited to one or two inner sheets. Additional inner sheets add detail to the ultimate resulting truss like structure of wall 700. Space 708 exists between first outer sheet 702 and second outer sheet 706. In other words, first outer sheet 702 is spaced from second outer sheet 706 by space 708. First inner sheet 704 and second inner sheet 705 are positioned within space 708. Space 708 is evacuated to include a vacuum. The vacuum in space 708 helps insulate a cryogenic fuel tank formed with wall 700.

First inner sheet 704 is diffusion bonded to first outer sheet 702 at first set of bond locations 710. Second inner sheet 705 is diffusion bonded to second outer sheet 706 at second set of bond locations 712. First inner sheet 704 may be folded upon itself at fold lines 714 and bonded to itself at fold lines 714 to form upper leg 716. Upper leg 716 extends from first outer sheet 702 in direction 730 across a portion of space 708 towards second outer sheet 706. First inner sheet 704 may include cut-outs 722. Cut-outs 722 may be any desired shape. All cut-outs 722 do not have to be the same shape. Second inner sheet 705 may be folded upon itself and bonded to itself in a similar fashion to form lower leg 718. Lower leg 718 extends from second outer sheet 706 in direction 732 across a portion of space 708 towards first outer sheet 702. First inner sheet 704 is bonded to second inner sheet 705 where upper leg 716 meets lower leg 718. Upper leg 716 is bonded to lower leg 718 at bond locations represented at 740. Upper leg 716 is bonded to lower leg 718 forming a complete leg or tower 744 between first outer sheet 702 and second outer sheet 706.

Towers 744 of the inner sheets form an integrally formed support structure bonded to and extending between first outer sheet 702 and second outer sheet 706. Towers 744 integrally support first outer sheet 702 and second outer sheet 706 in a truss like structure. Cut-outs 722 can vary in shape effecting a shape of tower 744.

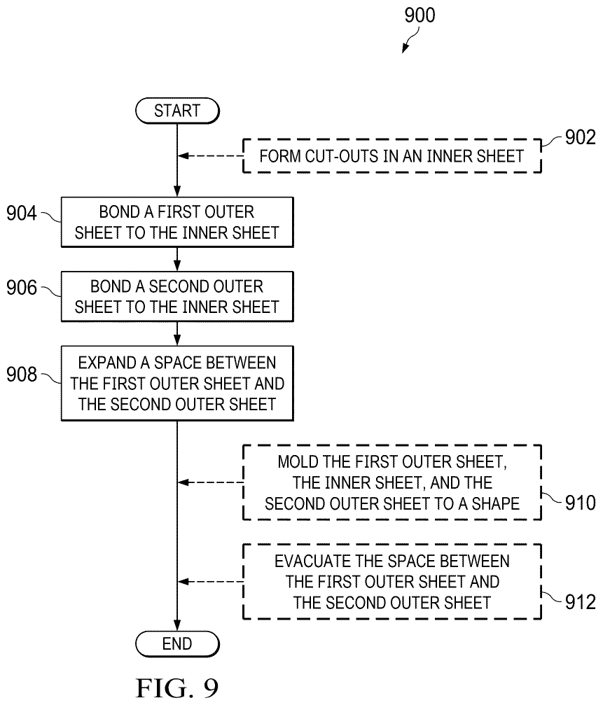

With reference next to FIG. 9, an illustration of a flowchart of a process 900 for forming a cryogenic fuel tank for an aircraft is depicted in accordance with an illustrative embodiment. The method depicted in FIG. 9 may be used in conjunction with the cryogenic fuel tank depicted in FIGS. 1-8.

The process may begin by forming cut-outs in an inner sheet (operation 902). Forming cut-outs is optional. Cut-outs may be any shape desired and not all cut-outs need to be the same shape. The shape of the cut-outs will be determined by the desired use of the inner sheet and the cryogenic fuel tank being formed. The inner sheet may not include cut-outs. The process continues by bonding a first outer sheet to the inner sheet (operation 904). The first outer sheet is bonded or diffusion bonded to the inner sheet at a first set of bond locations. The process continues by bonding a second outer sheet to the inner sheet (operation 906). The second outer sheet is bonded or diffusion bonded to the inner sheet at a second set of bond locations. The second set of bond locations is offset from the first set of bond locations. At operation 908, the process expands a space between the first outer sheet and the second outer sheet. Because the inner sheet is bonded to both the first outer sheet and the second outer sheet, the inner sheet extends between the first outer sheet and the second outer sheet and forms an integrally formed support structure extending from the first set of bond locations to the second set of bond locations. Operations 904 and 906 comprise the Diffusion Bonding portion of the SPFDB process. Operation 908 comprises the Super Plastic Forming functions of SPFDB. At operation 910, the process molds the first outer sheet, the inner sheet, and the second outer sheet between dies to a shape for a cryogenic fuel tank that conforms to a shape of the aircraft. A cryogenic fuel tank formed by this process may be manufactured to a shape of an open or preexisting space or structure of an aircraft. For example, either outer sheet may be an outside skin of the aircraft such as the skin of the fuselage or the skin of a wing. A cryogenic fuel tank formed by this process is conformal and not limited to the shapes of standard Dewar style cryogenic tanks. At operation 912, the process evacuates the space between the first outer sheet and the second outer sheet to create a vacuum in the space. The vacuum helps insulate a cryogenic fuel tank formed by this process and reduces thermal loss of any cryogenic liquids stored therein.

In some alternative implementations of an illustrative example, the function or functions noted in the blocks may not be necessary or may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

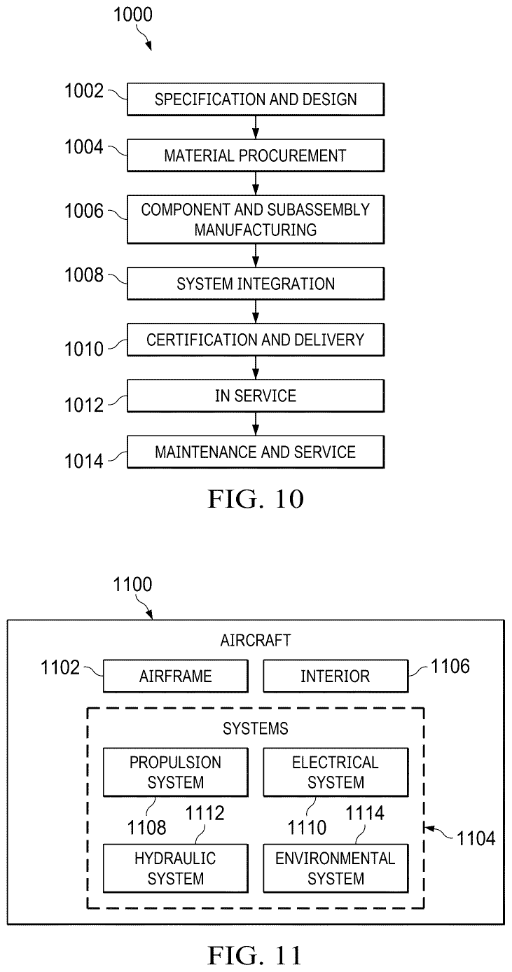

The illustrative embodiments of the disclosure may be further described in the context of aircraft manufacturing and service method 1000 as shown in FIG. 10 and aircraft 1100 as shown in FIG. 11. Turning first to FIG. 10, an illustration of a block diagram of an aircraft manufacturing and service method is depicted in accordance with an illustrative embodiment. During pre-production, aircraft manufacturing and service method 1000 may include specification and design 1002 of aircraft 1100 in FIG. 11 and material procurement 1004.

During production, component, and subassembly manufacturing 1006 and system integration 1008 of aircraft 1100 in FIG. 11 takes place. Thereafter, aircraft 1100 in FIG. 11 may go through certification and delivery 1010 in order to be placed in service 1012. While in service 1012 by a customer, aircraft 1100 in FIG. 11 is scheduled for routine maintenance and service 1014, which may include modification, reconfiguration, refurbishment, and other maintenance, service, or inspection.

The apparatus of this disclosure may be installed on an aircraft during component and subassembly manufacturing 1006. In addition, the apparatus of this disclosure may be retrofitted onto aircraft 1100 in FIG. 11 during routine maintenance and service 1014 as part of a modification, reconfiguration, or refurbishment of aircraft 1100 in FIG. 11.

Each of the processes of aircraft manufacturing and service method 1000 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers, and an operator may be an airline, a leasing company, a military entity, a service organization, and so on.

With reference now to FIG. 11, an illustration of a block diagram of an aircraft is depicted in which an illustrative embodiment may be implemented. In this example, aircraft 1100 is produced by aircraft manufacturing and service method 1000 in FIG. 10 and may include airframe 1102 with plurality of systems 1104 and interior 1106. Examples of systems 1104 include one or more of propulsion system 1108, electrical system 1110, hydraulic system 1112, and environmental system 1114. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1000 in FIG. 10. In one illustrative example, components or subassemblies produced in component and subassembly manufacturing 1006 in FIG. 10 may be fabricated or manufactured in a manner similar to components or subassemblies produced while aircraft 1100 is in service 1012 in FIG. 10. As yet another example, one or more apparatus embodiments, method embodiments, or a combination thereof may be utilized during production stages, such as component and subassembly manufacturing 1006 and system integration 1008 in FIG. 10. One or more apparatus embodiments, method embodiments, or a combination thereof may be utilized while aircraft 1100 is in service 1012, during maintenance and service 1014, inclusive of inspection, in FIG. 10, or both. The use of a number of the different illustrative embodiments may substantially expedite the assembly of aircraft 1100, reduce the cost of aircraft 1100, or both expedite the assembly of aircraft 1100 and reduce the cost of aircraft 1100.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A cryogenic fuel tank for an aircraft, comprising:
a first outer sheet spaced from a second outer sheet; and
an inner sheet positioned between the first outer sheet and the second outer sheet;
wherein the inner sheet is bonded to the first outer sheet at a first set of bond locations and the inner sheet is bonded to the second outer sheet at a second set of bond locations, the first set of bond locations offset from the second set of bond locations.

2. The cryogenic fuel tank of claim 1, wherein the inner sheet comprises cut-outs.

3. The cryogenic fuel tank of claim 1, wherein the inner sheet forms legs that extend from the first set of bond locations to the second set of bond locations.

4. The cryogenic fuel tank of claim 1, wherein the cryogenic fuel tank is a structural component of the aircraft.

5. The cryogenic fuel tank of claim 1, wherein the first outer sheet, the second outer sheet, and the inner sheet are each comprised of titanium.

6. The cryogenic fuel tank of claim 1, wherein the inner sheet is a plurality of stacked inner sheets positioned between the first outer sheet and the second outer sheet.

7. The cryogenic fuel tank of claim 6, wherein a first inner sheet of the plurality of stacked inner sheets is bonded to the first outer sheet and a second inner sheet of the plurality of stacked inner sheets is bonded to the second outer sheet.

8. The cryogenic fuel tank of claim 7, wherein the first inner sheet of the plurality of stacked inner sheets is bonded to the second inner sheet of the plurality of stacked inner sheets.

9. The cryogenic fuel tank of claim 6, wherein a portion of a first inner sheet of the plurality of stacked inner sheets is folded and bonded to itself to form an upper leg, wherein a portion of a second inner sheet of the plurality of stacked inner sheets is folded and bonded to itself to form a lower leg, and wherein the upper leg is bonded to the lower leg.

10. A cryogenic fuel tank system for an aircraft, comprising:
a first outer sheet bonded to an inner sheet;
a second outer sheet bonded to the inner sheet; and
a space between the first outer sheet and the second outer sheet, the space comprising a vacuum;
wherein the inner sheet extends between the first outer sheet and the second outer sheet and forms an integrally formed support structure between the first outer sheet and the second outer sheet.

11. The cryogenic fuel tank system of claim 10, wherein the inner sheet is bonded to the first outer sheet at a first set of bond locations and the inner sheet is bonded to the second outer sheet at a second set of bond locations, the first set of bond locations offset from the second set of bond locations.

12. The cryogenic fuel tank system of claim 11, wherein the inner sheet comprises cut-outs positioned between the first set of bond locations and the second set of bond locations.

13. The cryogenic fuel tank system of claim 10, wherein the inner sheet is a plurality of stacked inner sheets and a first inner sheet of the plurality of stacked inner sheets is bonded to the first outer sheet and a second inner sheet of the plurality of stacked inner sheets is bonded to the second outer sheet.

14. The cryogenic fuel tank system of claim 13, wherein the first inner sheet of the plurality of stacked inner sheets is bonded to the second inner sheet of the plurality of stacked inner sheets.

15. The cryogenic fuel tank system of claim 13, wherein a portion of the first inner sheet of the plurality of stacked inner sheets is folded and bonded to itself to form an upper leg, wherein a portion of the second inner sheet of the plurality of stacked inner sheets is folded and bonded to itself to form a lower leg, and wherein the upper leg is bonded to the lower leg.

16. The cryogenic fuel tank system of claim 10, wherein the first outer sheet, the inner sheet, and the second outer sheet are molded to a shape in order to conform to a shape of the aircraft.

17. The cryogenic fuel tank system of claim 16, wherein the shape of the first outer sheet, the inner sheet, and the second outer sheet has a varied thickness.

18. A method for forming a cryogenic fuel tank for an aircraft, comprising:
bonding a first outer sheet to an inner sheet at a first set of bond locations;
bonding a second outer sheet to the inner sheet at a second set of bond locations, the second set of bond locations offset from the first set of bond locations;
expanding a space between the first outer sheet and the second outer sheet such that the inner sheet extends between the first outer sheet and the second outer sheet and forms an integrally formed support structure extending from the first set of bond locations to the second set of bond locations.

19. The method of claim 18, further comprising:
forming cut-outs in the inner sheet.

20. The method of claim 18, further comprising:
molding the first outer sheet, the inner sheet, and the second outer sheet between dies to a shape that conforms to a shape of the aircraft.
